(19) United States
(12) Patent Application Publication
(10) Pub. No.: US 2025/0299410 A1
(43) Pub. Date: Sep. 25, 2025

(54) DISTRIBUTING COMMUNICATION AND COMPUTING OF SPLIT RENDERING OF MEDIA DATA

(71) Applicant: QUALCOMM Incorporated, San Diego, CA (US)

(72) Inventors: Simone Merlin, San Diego, CA (US); Imed Bouazizi, Frisco, TX (US); Liangping Ma, San Diego, CA (US); Nikolai Konrad Leung, San Francisco, CA (US)

(21) Appl. No.: 18/609,512

(22) Filed: Mar. 19, 2024

(51) Int. Cl. G06T 15/00; G06T 19/00; H04L 67/101

(52) U.S. Cl. CPC G06T 15/005; G06T 19/006; H04L 67/101

(57) ABSTRACT

An example optimizer system for processing extended reality (XR) media data is configured to: determine a first set of XR media data rendering tasks of an XR session to be performed by at least one server device and a second set of XR media data rendering tasks of the XR session to be performed by a first user equipment (UE) device; send a first set of instructions to the at least one server device representative of the first set of XR media data rendering tasks to cause the at least one server device to perform the first set of XR media data rendering tasks of the XR session; and send a second set of instructions to the first UE device representative of the second set of XR media data rendering tasks to cause the first UE device to perform the second set of XR media data rendering tasks.

### TECHNICAL FIELD

This disclosure relates to rendering of extended reality media data.

### BACKGROUND

Extended reality (XR) generally refers to one or more of a variety of techniques by which a computing device may present a three-dimensional (3D) scene to a user. XR may include, for example, augmented reality (AR), mixed reality (MR), or virtual reality (VR). XR may therefore be considered as a generic term for various technologies that alter reality through the addition of digital elements to a physical or real-world environment. AR may refer to presentation of a digital layer over physical elements of the real-world environment. MR may refer to the inclusion of digital elements that may interact with the physical elements. VR may refer to a fully immersive digital environment. In any case, a user may be presented with a 3D scene that the user may navigate and/or interact with.

### SUMMARY

In general, this disclosure describes techniques related to split rendering of extended reality (XR) data, such as augmented reality (AR), mixed reality (MR), or virtual reality (VR) data. Split rendering generally refers to situations in which a first device, such as a cloud server device, at least partially renders the XR data, then a second device, such as user equipment (UE) device, finishes the rendering of the XR data for presentation to a user. Per the techniques of this disclosure, an optimizer system may determine how to split rendering tasks between one or more network rendering devices and an endpoint UE device. For example, the optimizer system may determine which of a set of network rendering devices should be used to perform network rendering of XR media data. Additionally, the optimizer system may determine which rendering tasks should be performed by one or more network rendering devices vs. which rendering tasks should be performed by the endpoint UE device.

In one example, a method of processing extended reality (XR) media data includes: determining, by an optimizer system, a first set of XR media data rendering tasks of an XR session to be performed by at least one server device and a second set of XR media data rendering tasks of the XR session to be performed by a user equipment (UE) device; sending, by the optimizer system, a first set of instructions to the at least one server device representative of the first set of XR media data rendering tasks to cause the at least one server device to perform the first set of XR media data rendering tasks of the XR session; and sending, by the optimizer system, a second set of instructions to the UE device representative of the second set of XR media data rendering tasks to cause the UE device to perform the second set of XR media data rendering tasks.

In another example, an optimizer system for processing extended reality (XR) media data includes: a memory configured to store optimization configuration data; and a processing system comprising one or more processors implemented in circuitry, the processing system being configured to: determine, according to the optimization configuration data, a first set of XR media data rendering tasks of an XR session to be performed by at least one server device and a second set of XR media data rendering tasks of the XR session to be performed by a user equipment (UE) device; send a first set of instructions to the at least one server device representative of the first set of XR media data rendering tasks to cause the at least one server device to perform the first set of XR media data rendering tasks of the XR session; and send a second set of instructions to the UE device representative of the second set of XR media data rendering tasks to cause the UE device to perform the second set of XR media data rendering tasks.

In another example, a method of processing extended reality (XR) media data includes: receiving, by a network rendering device configured to partially render XR media data and from an optimizer system, a set of instructions representative of a first set of XR media data rendering tasks to be performed on XR media data of an XR session, wherein a user equipment (UE) device participates in the XR session; receiving, by the network rendering device, the XR media data of the XR session; performing, by the network rendering device, the first set of XR media data rendering tasks on the XR media data to form partially rendered XR media data; and sending, by the network rendering device, the partially rendered XR media data to the UE device.

In another example, a network rendering device for partially rendering extended reality (XR) media data includes: a memory configured to store XR media data; and a processing system comprising one or more processors implemented in circuitry, the processing system being configured to: receive, from an optimizer system, a set of instructions representative of a first set of XR media data rendering tasks to be performed on XR media data of an XR session, wherein a user equipment (UE) device participates in the XR session; receive the XR media data of the XR session; perform the first set of XR media data rendering tasks on the XR media data to form partially rendered XR media data; and send the partially rendered XR media data to the UE device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing system that may perform techniques of this disclosure.

FIG. 2 is a block diagram illustrating an example network including various devices for performing the techniques of this disclosure.

FIG. 3 is a conceptual diagram illustrating an example network including devices that may be configured to perform the techniques of this disclosure.

FIG. 4 is a block diagram of an example optimization system according to techniques of this disclosure.

FIGS. 5-7 are flow diagrams illustrating an example method of optimizing network-based split rendering of extended reality (XR) media data according to techniques of this disclosure.

### DETAILED DESCRIPTION

Augmented reality (AR) calls (or other extended reality (XR) media communication sessions, such as mixed reality (MR) or virtual reality (VR)) may require significant processing resources to render content of the AR call scene, especially when multiple participants contribute to the creation of a complex AR call scene. These scenes may include a virtual environment that may be anchored to a real world location, as well as content from all participants in the call. Content from a participant may include, for example, user avatars, slide materials, 3D virtual objects, etc.

Physically based rendering (PBR) may be included in rendering AR or other XR data. PBR generally includes rendering image data through emulating light transmission in a virtual world to recreate real world lighting, including user shadows and object reflections on specular surfaces. Advanced rendering capabilities such as PBR may not be available to certain devices, such as AR glasses and head mounted displays (HMDs), or may require too much power to run on such devices.

The techniques of this disclosure include using signaling to invoke split rendering (also referred to herein as “network rendering”) for an AR call over IP Multimedia Subsystem (IMS). Using such signaling, a client device (e.g., a user equipment (UE)) may signal to another device that the client device is requesting split rendering, where the other device will render image data from AR data of an AR media communication session, and the client device will present the rendered image data. The client device may be, for example, an HMD, AR glasses, or the like. The other device may be an AR application server (AS). In this manner, such devices may be capable of participating in an AR communication session, even when such devices are not capable of rendering AR data. Additionally, upstream devices that are capable of rendering AR data may receive a request to render the AR device on behalf of another device, such as a UE, HMD, or AR glasses, and render the AR data on behalf of the other device, thereby achieving split rendering.

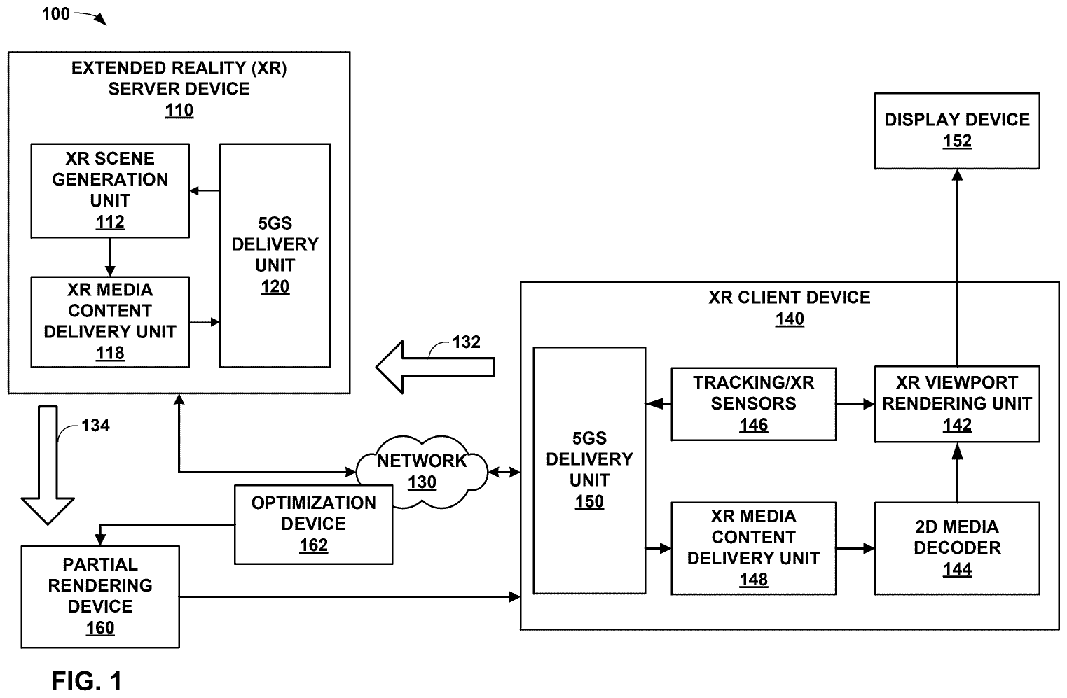

FIG. 1 is a block diagram illustrating an example computing system 100 that may perform techniques of this disclosure. In this example, computing system 100 includes extended reality (XR) server device 110, network 130, XR client device 140, and display device 152. XR server device 110 includes XR scene generation unit 112, XR media content delivery unit 118, and 5G System (5GS) delivery unit 120. Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. XR client device 140 includes 5GS delivery unit 150, tracking/XR sensors 146, XR viewport rendering unit 142, 2D media decoder 144, and XR media content delivery unit 148. XR client device 140 also interfaces with display device 152 to present XR media data to a user (not shown).

In some examples, XR scene generation unit 112 may correspond to an interactive media entertainment application, such as a video game, which may be executed by one or more processors implemented in circuitry of XR server device 110. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 150. XR viewport rendering unit 142 may use the location and orientation data to complete an XR rendering process, that was partially performed by partial rendering device 160. XR client device 140 provides tracking and sensor information 132 to XR server device 110 via network 130. XR server device 110, in turn, receives tracking and sensor information 132 and provides this information to XR scene generation unit 112. In this manner, XR scene generation unit 112 can generate scene data for the user's viewport and location.

System 100 also includes partial rendering device 160. Partial rendering device 160 may generally perform a first set of XR rendering tasks, then provide partially rendered XR media data to XR client device 140, which may complete the XR rendering process.

Per the techniques of this disclosure, system 100 includes optimization device 162. Optimization device 162 may generally be configured to determine a distribution of rendering tasks between partial rendering device 160 and XR client device 140. Initially, XR client device 140 may submit a request to optimization device 162 via network 130 for split rendering. The request may further include one or more of: session information, which may include the IP addresses of XR client device 140 and another client device involved in the XR session, protocol number, port numbers, or the like; media capability and compute capability of XR client device 140 and the other client device involved in the XR session; an application for the XR session (e.g., avatar call, VR, multi-user gaming, or the like); content of the XR session (e.g., high or low interactivity); task (e.g., evaluate road safety) and subtask(s) (e.g., object recognition, object tracking, segmentation, or the like); desired split point of the XR rendering process; required delay and/or throughput; quality of service (QOS) and/or quality of experience (QoE) requirements and how the network performance affects QoS/QoE (e.g., a model that provides QoS/QoE scores given the network performance); the locations of XR client device 140 and the other client device; and accessible access networks (e.g., Wi-Fi, 5G NR, LTE, or the like). The XR client device 140 and the other device involved in the XR session may be two endpoint devices of the XR session, e.g., two client devices that each send and receive XR information and present XR media data to respective users thereof.

Optimization device 162 may include a split compute unit (server) and a communication unit (server). In general, the split compute unit may determine how to split the compute (XR rendering process) for an application session (XR session), while the communication unit may determine how input data and intermediate results are routed (e.g., which access network to use and which core network to use). The intermediate results may be the results of the rendering process up to a split point, which may be completed by a separate computing device. Partial rendering device 160 represents an example of a compute entity in a network (e.g., network 130). Such compute entities may register their compute capabilities with the split compute unit of optimization device 162. Such capabilities may include hardware units, installed software, and/or other compute elements.

Optimization device 162 may also include a network metrics application programming interface (API). Network devices (e.g., software defined network (SDN) controllers or network exposure functions (NEFs)) may register network metrics with the communication unit of optimization device 162 via the network metrics API. Such network metrics may include IP addresses of ingress points and egress points, and delay and throughput between each pair of ingress and egress points for a particular type of traffic flow (voice, video, haptic, etc.). In this manner, optimization device 162 may determine available network capacity, and thus, determine routing of XR media data between the ingress and egress points.

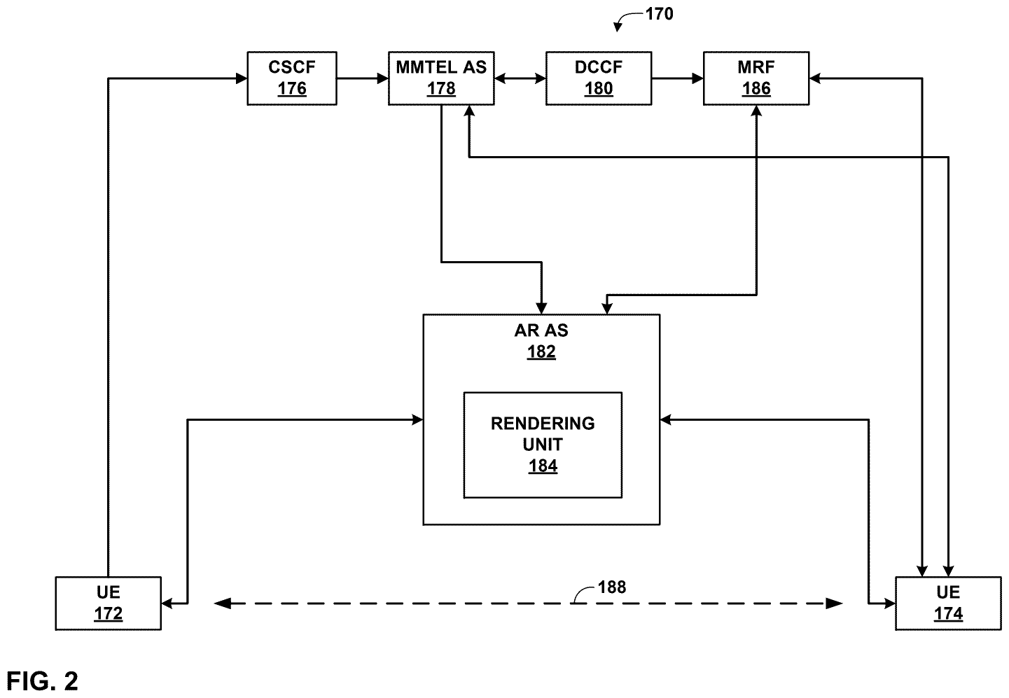

FIG. 2 is a block diagram illustrating an example network 170 including various devices for performing the techniques of this disclosure. In this example, network 170 includes user equipment (UE) devices 172, 174, call session control function (CSCF) 176, multimedia telephony application server (MMTel AS) 178, data channel control function (DCCF) 180, multimedia resource function (MRF) 186, and augmented reality application server (AR AS) 182.

UEs 172, 174 represent examples of UEs that may participate in an AR communication session 188. That is, UEs 172, 174 may exchange AR media data related to a virtual scene, represented by a scene description. Users of UEs 172, 174 may view the virtual scene including virtual objects, as well as user AR data, such as avatars, shadows cast by the avatars, user virtual objects, user provided documents such as slides, images, videos, or the like, or other such data. Ultimately, users of UEs 172, 174 may experience an AR call from the perspective of their corresponding avatars (in first or third person) of virtual objects and avatars in the scene.

UEs 172, 174 may collect pose data for users of UEs 172, 174, respectively. For example, UEs 172, 174 may collect pose data including a position of the users, corresponding to positions within the virtual scene, as well as an orientation of a viewport, such as a direction in which the users are looking (i.e., an orientation of UEs 172, 174 in the real world, corresponding to virtual camera orientations). UEs 172, 174 may provide this pose data to AR AS 182 and/or to each other.

Each of UEs 172, 174 may generally perform the various functionality attributed to content preparation device 20, server device 60, and client device 40 of FIG. 1. However, according to the techniques of this disclosure, one of UEs 172, 174, e.g., UE 172, is not capable of performing 3D virtual object rendering and would not include a rendering unit for rendering 3D virtual objects into 2D images or video data. Thus, UE 172 would not perform the functionality of rendering unit 66 of FIG. 1. Instead, rendering unit 184 of AR AS 182 may perform the functionality of rendering unit 66 of FIG. 1 on behalf of UE 172, as discussed in greater detail below.

CSCF 176 may be a proxy CSCF (P-CSCF), an interrogating CSCF (I-CSCF), or serving CSCF (S-CSCF). CSCF 176 may generally authenticate users of UEs 172 and/or 174, inspect signaling for proper use, provide quality of service (QOS), provide policy enforcement, participate in session initiation protocol (SIP) communications, provide session control, direct messages to appropriate application server(s), provide routing services, or the like. CSCF 176 may represent one or more I/S/P CSCFs.

MMTel AS 178 represents an application server for providing voice, video, and other telephony services over a network, such as a 5G network. MMTel AS 178 may provide telephony applications and multimedia functions to UEs 172, 174.

DCCF 180 may act as an interface between MMTel AS 178 and MRF 186, to request data channel resources from MRF 186 and to confirm that data channel resources have been allocated. MRF 186 may be an enhanced MRF (eMRF) in some examples. In general, MRF 186 generates scene descriptions for each participant in an AR communication session.

AR AS 182 may participate in AR communication session 188 according to the techniques of this disclosure. In particular, AR AS 182 includes rendering unit 184. For purposes of example, it may be assumed that UE 172 is not capable of rendering virtual object data to form two-dimensional (2D) image or video data, even if UE 172 is capable of displaying/presenting such data. Thus, according to the techniques of this disclosure, rendering unit 184 of AR AS 182 may render the virtual object data, such as scene data, avatar data, pose information for the avatars as well as for a viewport of UE 172 (i.e., a direction in which the user of UE 172 is facing and/or is rotated), or the like. In this manner, UE 172 and AR AS 182 may perform split rendering. AR AS 182 may be an Edge AS that meets the requirements of an AR call.

A data channel for AR communication session 188 may distribute a scene description for AR communications session 188. The scene description may be used to compose the scene that will serve as a shared space for all participants (e.g., users of UEs 172, 174) in AR communication session 188 (which may also be referred to as an “AR call”). Each participant may declare support for the AR call, as well as rendering capabilities of respective UEs 172, 174 in an invitation to the AR call. UEs 172, 174 may receive respective scene descriptions that are tailored to rendering capabilities of UEs 172, 174. The scene descriptions may offer alternative representations that UEs 172, 174 may choose.

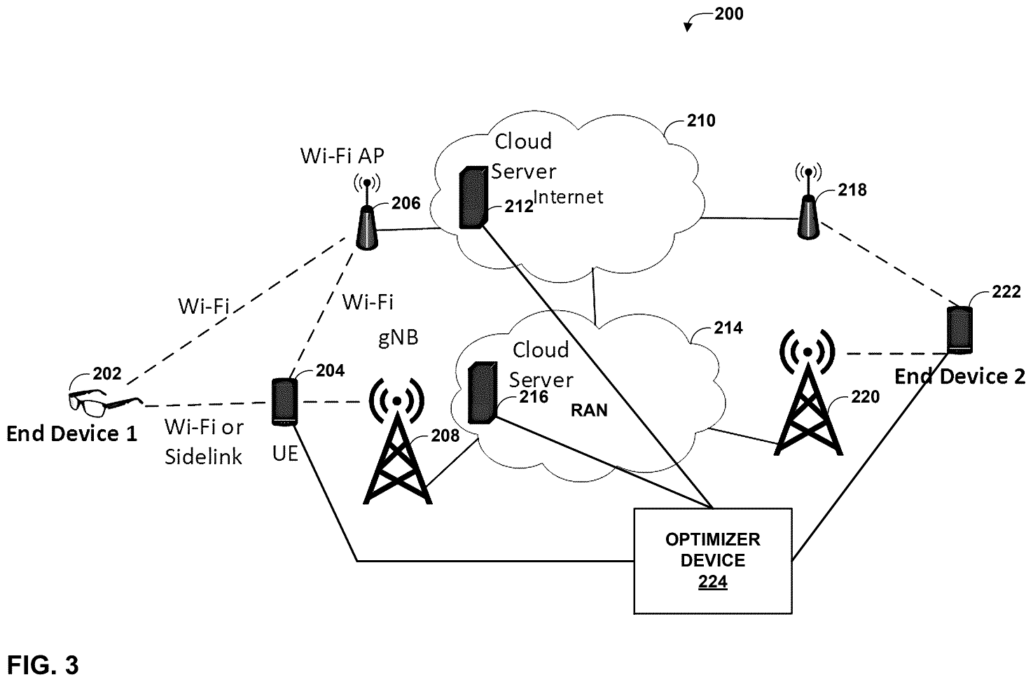

FIG. 3 is a conceptual diagram illustrating an example network 200 including devices that may be configured to perform the techniques of this disclosure. In this example, network 200 includes end device 202, user equipment (UE) 204, Wi-Fi access point 206, gNode B (gNB) 208, Internet 210, server device 212, wireless radio access network (RAN) (e.g., 5G cloud) 214, server device 216, Wi-Fi access point 218, gNB 220, end device 222, and optimizer device 224.

In general, end device 222 and UE 204 may engage in an extended reality (XR) media data session, also referred to herein as an “XR session.” Data for the XR session may traverse Internet 210 via, e.g., Wi-Fi access points 206 and 218 and/or RAN 214 via gNBs 208 and 220.

Server devices 212 and 216 may be configured to perform partial rendering of XR media data. For example, if XR media data traverses Internet 210 from end device 222 toward UE 204, server device 212 may partially render the XR media data and UE device 204 and/or end device 202 may finish rendering the XR media data for display by end device 202. Similarly, if XR media data traverses RAN 214, server device 216 may partially render the XR media data and UE device 204 and/or end device 202 may finish rendering the XR media data for display by end device 202.

Optimizer device 224, per the techniques of this disclosure, may determine a division of rendering tasks between, e.g., server device 212, server device 216, and/or UE 204, or other devices in Internet 210 and/or RAN 214 (which may be a cellular network, such as 5GC RAN). For example, optimizer device 224 may determine a first set of XR media data rendering tasks to be performed by server device 212 and a second set of XR media data rendering tasks to be performed by server device 216. Additionally or alternatively, optimizer device 224 may determine sets of XR media data rendering tasks to be performed by various server devices in Internet 212, including server device 212, and/or sets of XR media data rendering tasks to be performed by various server devices in RAN 214, including server device 216.

To determine tasks to be performed by a server device, such as one of server device 212 or server device 216, optimizer device 224 may request compute capabilities of the server devices. For example, optimizer device 224 may determine hardware devices of the server devices, such as central processing units (CPUs), graphics processing units (GPUs), network processing units (NPUs), and available random access memory (RAM). Additionally or alternatively, optimizer device 224 may determine software on the server devices, such as video encoder/decoder (CODECs) or neural network modules. Optimizer device 224 may further determine other elements of the server devices and/or UE device 204, such as compute pricing, energy consumption, battery status, and/or heat condition.

Furthermore, optimizer unit 224 may determine whether XR media data should be sent to UE device 204 via Internet 210 and/or via RAN 214. For example, optimizer unit 224 may determine a core network and one or more access networks through which XR media data is to be routed. Optimizer unit 224 may, for example, request network measurements from server devices of Internet 210, such as server device 212, and server devices of RAN 214, such as server device 216, and use the network measurements to determine the core network and/or access network(s). Such network measurements may include measurements from software defined network (SDN) controllers, network exposure functions (NEFs), or the like of RAN 214. The network measurements may indicate IP addresses of ingress and/or egress points of the networks, as well as delay and throughput between pairs of ingress points and egress points for a type of traffic flow (e.g., voice, video, haptic, or the like). Optimizer unit 224 may determine available capacity of links between ingress and egress points using such network measurements.

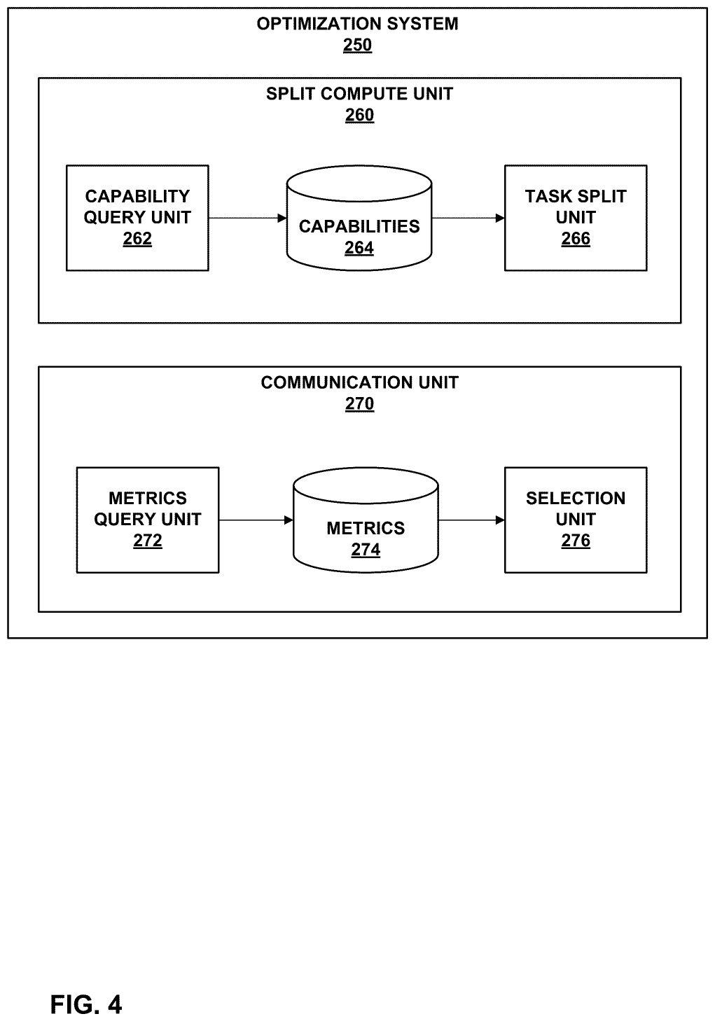

FIG. 4 is a block diagram of an example optimization system 250 according to techniques of this disclosure. In this example, optimization system 250 includes split compute unit 260 (which may also be referred to as a “split compute server”) and communication unit 270 (which may be referred to as a “communication server”).

Split compute unit 260 includes capability query unit 262, capabilities 264, and task split unit 266. Capability query unit 262 is generally configured to determine compute capabilities of server devices that may perform partial XR media data rendering on behalf of a downstream user equipment (UE) device. Such capabilities may include, for example, availability of hardware devices of the server devices, such as central processing units (CPUs), graphics processing units (GPUs), network processing units (NPUs), and/or available random access memory (RAM). Additionally or alternatively, capability query unit 262 may determine software on the server devices, such as video encoder/decoder (CODECs) or neural network modules. Capability query unit 262 may further determine other elements of the server devices and/or the downstream UE device, such as compute pricing, energy consumption, battery status, and/or heat condition.

Capability query unit 262 may store compute capabilities of each of the server devices in a memory, represented in FIG. 4 as capabilities 264. Task split unit 266 may then allocate tasks between one or more server devices configured to perform split rendering (network based rendering) of XR media data based on the capabilities of those devices and the downstream UE device.

Communication unit 270 includes metrics query unit 272, metrics 274, and selection unit 276. Query unit 272 may receive network metrics from the server devices or other network devices, such as software defined network (SDN) controller devices and/or network exposure function (NEF) devices. Such server devices and other network devices may register network metrics with communication unit 270. The network metrics may include IP addresses of ingress and egress points of the devices, as well as metrics such as delay and throughput between each pair of ingress and egress points for a type of traffic flow, such as voice data, video data, or haptic data.

Optimization system 250 may receive a request from a UE device for split rendering of XR media data. The request may also represent a request for network optimization of the split rendering. In addition, the request may carry one or more of session information (e.g., IP addresses of the UE device and another UE device engaged in the XR session, port numbers, and protocol number, thereby forming a network 5-tuple); media capabilities and compute capabilities for the UE devices; an application engaged in the XR session (e.g., an avatar call, VR, or multi-user gaming); content (e.g., high or low interactivity); a task to be performed (e.g., road safety evaluation) and subtasks (e.g., object recognition, object tracking, segmentation); a desired split point of the split rendering computation; a required delay or throughput; a quality of service (QoS)/quality of experience (QoE) requirement and how the network performance impacts QoS/QoE (e.g., a model that provides a QoS/QoE score given network performance); locations of the UE devices; and/or accessible access networks (e.g., Wi-Fi, 5G NR, LTE, etc.). After processing the request, optimization system 250 may trigger communication optimization through sending the QoS/QoE requirements through communication unit 270.

Communication unit 270 may update states of communication networks in response to the request from the downstream UE device. In one example, query unit 272 may initiate network measurements between the UE devices and the compute entities and reporting of network measurements. In another example, query unit 272 may initiate reporting of stored network metrics from potential communication networks that host potential compute entities. Communication unit 270 may then optimize the communication. In particular, query unit 272 may store collected network metrics to a memory represented in FIG. 4 as metrics 274. Selection unit 276 may then select access networks and candidates for performing the split rendering computation based on metrics 274.

Split compute unit 260 may select a combination of compute entities (server devices, for example) that meet the QoS/QoE requirements and configures these compute entities. For example, split compute unit 260 finds a combination of cloud servers (or edge servers) that meet the requirements, and one is in Network A (closer to End Device 1) and one in Network B (closer to End Device 2), split compute unit 260 may configure the selected compute entities, accept the split compute request, and send the configurations for both end devices to the requesting end device, which then forwards the configuration intended for the other end device to the other end device.

The end devices and the selected compute entities may then start the split rendering process. For example, the rendering process of an application (XR) session may be split into four parts: part 1 in End Device 1, part 2 in the cloud server of Network A, part 3 in the cloud server of Network B, and part 4 in End Device 2.

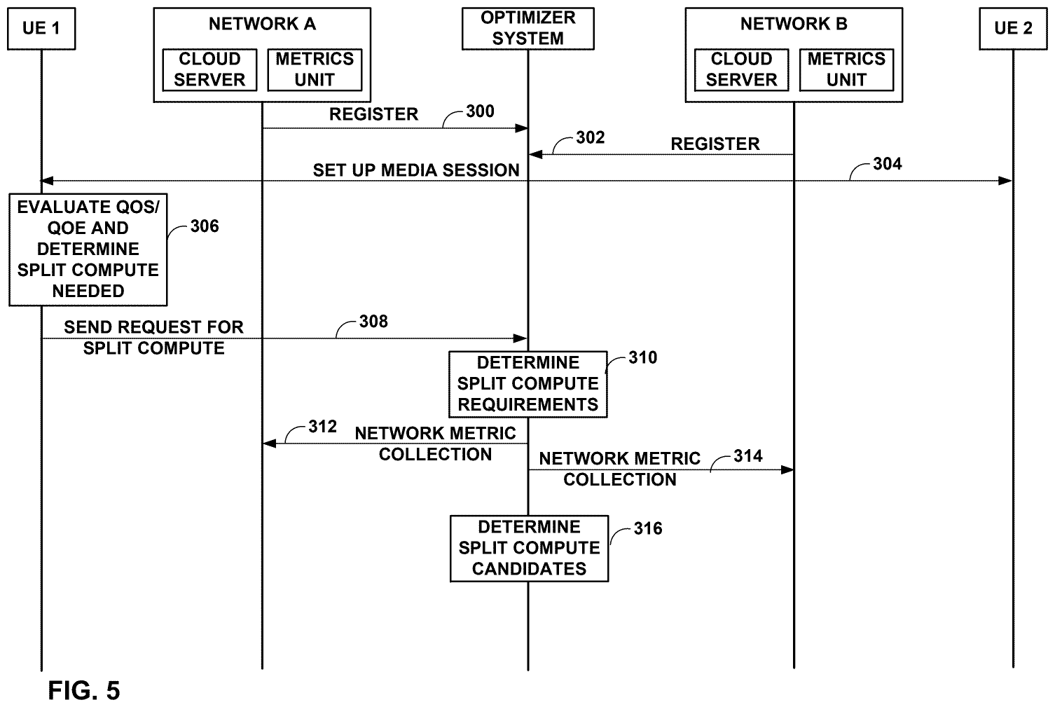

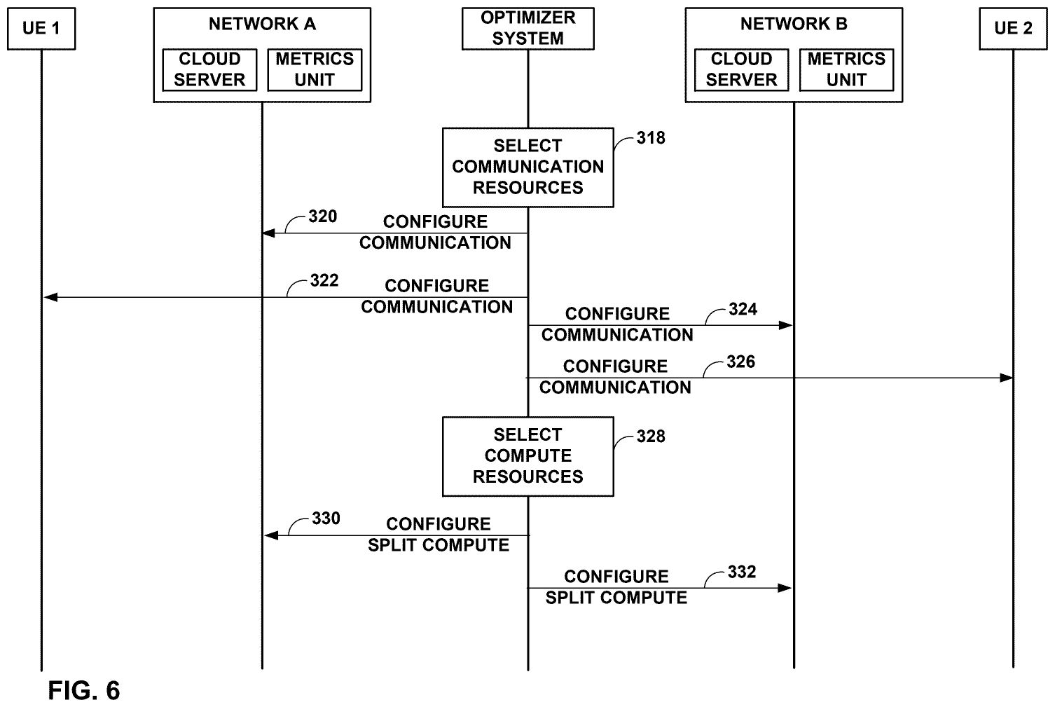

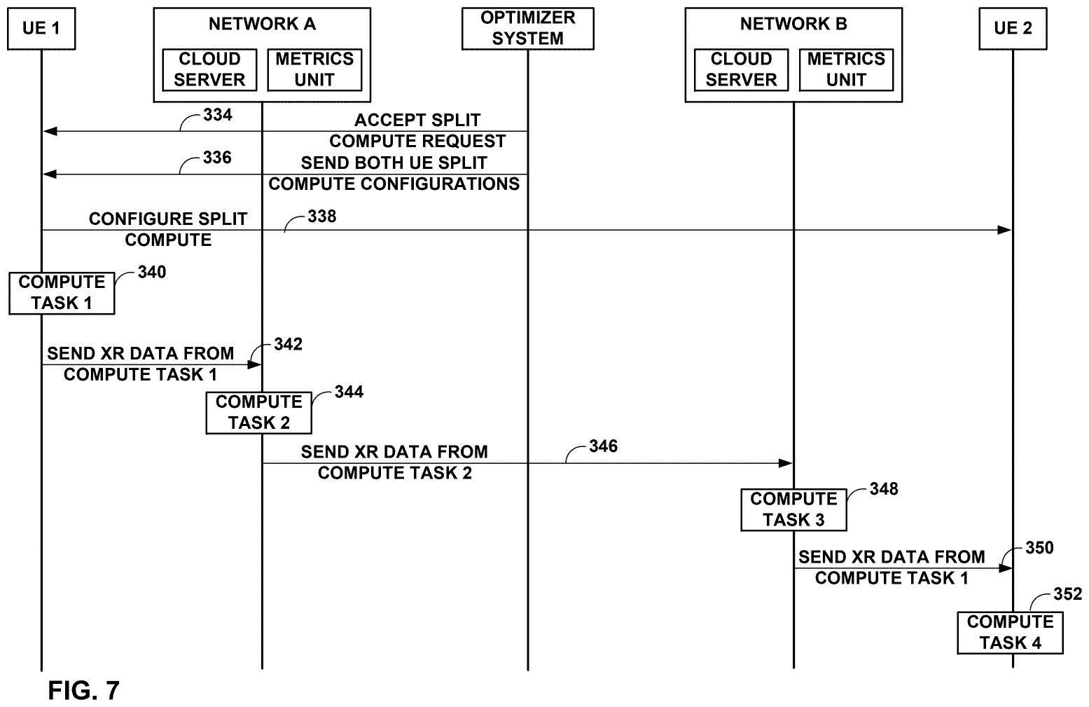

FIGS. 5-7 are flow diagrams illustrating an example method of optimizing network-based split rendering of extended reality (XR) media data according to techniques of this disclosure. The method of FIGS. 5-7 is performed by two user equipment (UE) devices, such as XR client device 140 and XR server device 110 of FIG. 1; UEs 172 and 174 of FIG. 2; or UE 204 and end device 222 of FIG. 3; cloud servers and metric units of various networks, such as partial rendering device 160 of FIG. 1; AR AS 182 of FIG. 2; or server devices 212, 216 of FIG. 3; and an optimizer system, such as optimization device 162; optimizer device 224 of FIG. 3, or optimization system 250 of FIG. 4.

Initially, server devices of the various networks register with the optimizer system (300, 302). For example, the server devices may provide compute capabilities, such as hardware, software, and other such information, to the optimizer system. The UEs may then set up a media session, such as an XR media session (304). A first UE device may then evaluate QoS/QoE requirements for the media session and determine that split rendering is needed for the media session (306). Thus, the first UE device may send a request for split rendering to the optimizer system (308). The request may include media rendering capabilities of the first UE device, compute capabilities of the first UE device, a content type, task(s) to be performed, the QoS/QoE requirement(s), locations of the first and second UE devices, or the like. The optimizer system may receive the request from the first UE device and determine the split compute requirements from the request (310).

The optimizer system may then collect network metrics from networks between the first and second UE devices (312, 314). For example, the optimizer system may configure measurement collection between the first and second UE devices and respective server devices of the networks, and the UE devices may then report the measurement results to the optimizer system. Additionally or alternatively, the optimizer system may request stored network metrics from the server devices, and the server devices may report the metrics to the optimizer system accordingly. Using the network measurements, the optimizer system may determine split compute candidates of the various networks (316).

The optimizer system may further select communication resources (318), such as core networks and/or access networks (e.g., cellular networks, Wi-Fi, etc.). The optimizer system may then configure communication with the server devices (320, 324) and the UEs (322, 326). Such communication configuration may indicate source and destination devices along a network path between the UEs. The optimizer system may further select compute resources (e.g., cloud server devices, edge server devices, or the like) of the selected networks to perform split rendering (328). The optimizer system may configure the selected compute resources to perform split rendering (330, 332). Such configuration may indicate, for example, rendering tasks to be performed by each device.

After such configuration, the optimizer system may send an accept message in response to the request to the first UE (334). The optimizer system may send configuration data for both the first UE and the second UE. In some examples, the optimizer system may send configuration data for both the first UE and the second UE to the first UE (336), and the first UE may redirect the configuration data for the second UE to the second UE (338).

Thus, during the media session, the first UE may perform a first compute task (340), and send XR media data resulting from the first compute task to a server device of Network A (342). The server device of Network A may perform a second compute task (344) and send XR data resulting from the second compute task to a server device of Network B (346). The server device of Network B may then perform a third compute task (348) and send XR data resulting from the third compute task to the second UE (350). Ultimately, the second UE may perform a fourth compute task (352), thereby finalizing the rendering process. The second UE may thus generate media data for output by a display device, which may be integrated into or separate from the second UE device.

In this manner, the method of FIGS. 5-7 represents an example of a method of processing extended reality (XR) media data, including determining, by an optimizer system, a first set of XR media data rendering tasks of an XR session to be performed by at least one server device and a second set of XR media data rendering tasks of the XR session to be performed by a user equipment (UE) device; sending, by the optimizer system, a first set of instructions to the at least one server device representative of the first set of XR media data rendering tasks to cause the at least one server device to perform the first set of XR media data rendering tasks of the XR session; and sending, by the optimizer system, a second set of instructions to the UE device representative of the second set of XR media data rendering tasks to cause the UE device to perform the second set of XR media data rendering tasks.

The method of FIGS. 5-7 also represents an example of a method of processing extended reality (XR) media data, including: receiving, by a network rendering device configured to partially render XR media data and from an optimizer system, a set of instructions representative of a first set of XR media data rendering tasks to be performed on XR media data of an XR session, wherein a user equipment (UE) device participates in the XR session; receiving, by the network rendering device, the XR media data of the XR session; performing, by the network rendering device, the first set of XR media data rendering tasks on the XR media data to form partially rendered XR media data; and sending, by the network rendering device, the partially rendered XR media data to the UE device.

The clauses below represent various examples of the techniques of this disclosure:

Clause 1: A method of processing extended reality (XR) media data, the method comprising: determining, by an optimizer system, a first set of XR media data rendering tasks of an XR session to be performed by at least one server device and a second set of XR media data rendering tasks of the XR session to be performed by a user equipment (UE) device; sending, by the optimizer system, a first set of instructions to the at least one server device representative of the first set of XR media data rendering tasks to cause the at least one server device to perform the first set of XR media data rendering tasks of the XR session; and sending, by the optimizer system, a second set of instructions to the UE device representative of the second set of XR media data rendering tasks to cause the UE device to perform the second set of XR media data rendering tasks.

Clause 2: The method of clause 1, wherein determining the first set of XR media data rendering tasks comprises: determining a first subset of the first set of XR media data rendering tasks to be performed by the at least one server device; and determining a second subset of the first set of XR media data rendering tasks to be performed by a second, different server device.

Clause 3: The method of clause 2, wherein determining the first subset and the second subset comprises determining the first subset and the second subset by a split compute unit of the optimizer system.

Clause 4: The method of clause 2, further comprising receiving, by the optimizer system, compute capabilities of the at least one server device and the second, different server device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 5: The method of clause 1, further comprising determining, by a communication unit of the optimizer system, routing of input data received from a second UE device involved in the XR session and intermediate results to the UE device.

Clause 6: The method of clause 5, wherein determining the routing comprises determining one or more access networks and a core network through which the input data and the intermediate results are to be routed.

Clause 7: The method of clause 5, further comprising: receiving first network measurements for connections between the UE device and the at least one server device; and receiving second network measurements for connections between the UE device and the second, different server device; wherein determining the first subset of the first set of XR media data rendering tasks comprises determining the first subset of the first set of XR media data rendering tasks according to the first network measurements, and wherein determining the second subset of the first set of XR media data rendering tasks comprises determining the second subset of the first set of XR media data rendering tasks according to the second network measurements.

Clause 8: The method of clause 7, wherein receiving the first network measurements comprises initiating, by the optimizer system, the first network measurements; and wherein receiving the second network measurements comprises initiating, by the optimizer system, the second network measurements.

Clause 9: The method of clause 7, wherein receiving the first network measurements comprises initiating, by the optimizer system, reporting of the first network measurements; and wherein receiving the second network measurements comprises initiating, by the optimizer system, reporting of the second network measurements.

Clause 10: An optimizer system for processing extended reality (XR) media data, the optimizer system comprising: a memory configured to store optimization configuration data; and a processing system comprising one or more processors implemented in circuitry, the processing system being configured to: determine, according to the optimization configuration data, a first set of XR media data rendering tasks of an XR session to be performed by at least one server device and a second set of XR media data rendering tasks of the XR session to be performed by a user equipment (UE) device; send a first set of instructions to the at least one server device representative of the first set of XR media data rendering tasks to cause the at least one server device to perform the first set of XR media data rendering tasks of the XR session; and send a second set of instructions to the UE device representative of the second set of XR media data rendering tasks to cause the UE device to perform the second set of XR media data rendering tasks.

Clause 11: The optimizer system of clause 10, wherein to determine the first set of XR media data rendering tasks, the processing system is configured to: determine a first subset of the first set of XR media data rendering tasks to be performed by the at least one server device; and determine a second subset of the first set of XR media data rendering tasks to be performed by a second, different server device.

Clause 12: The optimizer system of clause 11, wherein the processing system includes a split compute unit implemented in circuitry and configured to determine the first subset and the second subset.

Clause 13: The optimizer system of clause 11, wherein the processing system is further configured to receive compute capabilities of the at least one server device and the second, different server device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 14: The optimizer system of clause 10, wherein the processing system comprises a communication unit implemented in circuitry and configured to determine routing of input data received from a second UE device involved in the XR session and intermediate results through one or more access networks and a core network to the UE device.

Clause 15: The optimizer system of clause 14, wherein the communication unit is further configured to: receive first network measurements for connections between the UE device and the at least one server device; and receive second network measurements for connections between the UE device and the second, different server device; wherein the communication unit is configured to determine the first subset of the first set of XR media data rendering tasks according to the first network measurements, and wherein the communication unit is configured to determine the second subset of the first set of XR media data rendering tasks according to the second network measurements.

Clause 16: The optimizer system of clause 15, wherein the communication unit is configured to initiate the first network measurements; and wherein the communication unit is configured to initiate the second network measurements.

Clause 17: The optimizer system of clause 15, wherein the communication unit is configured to initiate reporting of the first network measurements to initiate reporting of the second network measurements.

Clause 18: A method of processing extended reality (XR) media data, the method comprising: receiving, by a network rendering device configured to partially render XR media data and from an optimizer system, a set of instructions representative of a first set of XR media data rendering tasks to be performed on XR media data of an XR session, wherein a user equipment (UE) device participates in the XR session; receiving, by the network rendering device, the XR media data of the XR session; performing, by the network rendering device, the first set of XR media data rendering tasks on the XR media data to form partially rendered XR media data; and sending, by the network rendering device, the partially rendered XR media data to the UE device.

Clause 19: The method of clause 18, further comprising sending, to the optimizer system, compute capabilities of the network rendering device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 20: The method of clause 18, further comprising sending network measurements for connections between the UE device and the network rendering device to the optimizer system.

Clause 21: A network rendering device for partially rendering extended reality (XR) media data, the network rendering device comprising: a memory configured to store XR media data; and a processing system comprising one or more processors implemented in circuitry, the processing system being configured to: receive, from an optimizer system, a set of instructions representative of a first set of XR media data rendering tasks to be performed on XR media data of an XR session, wherein a user equipment (UE) device participates in the XR session; receive the XR media data of the XR session; perform the first set of XR media data rendering tasks on the XR media data to form partially rendered XR media data; and send the partially rendered XR media data to the UE device.

Clause 22: The network rendering device of clause 21, wherein the processing system is further configured to send, to the optimizer system, compute capabilities of the network rendering device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 23: The network rendering device of clause 21, wherein the processing system is further configured to send network measurements for connections between the UE device and the network rendering device to the optimizer system.

Clause 24: A method of processing extended reality (XR) media data, the method comprising: determining, by an optimizer system, a first set of XR media data rendering tasks of an XR session to be performed by at least one server device and a second set of XR media data rendering tasks of the XR session to be performed by a user equipment (UE) device; sending, by the optimizer system, a first set of instructions to the at least one server device representative of the first set of XR media data rendering tasks to cause the at least one server device to perform the first set of XR media data rendering tasks of the XR session; and sending, by the optimizer system, a second set of instructions to the UE device representative of the second set of XR media data rendering tasks to cause the UE device to perform the second set of XR media data rendering tasks.

Clause 25: The method of clause 24, wherein determining the first set of XR media data rendering tasks comprises: determining a first subset of the first set of XR media data rendering tasks to be performed by the at least one server device; and determining a second subset of the first set of XR media data rendering tasks to be performed by a second, different server device.

Clause 26: The method of clause 25, wherein determining the first subset and the second subset comprises determining the first subset and the second subset by a split compute unit of the optimizer system.

Clause 27: The method of any of clauses 25 and 26, further comprising receiving, by the optimizer system, compute capabilities of the at least one server device and the second, different server device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 28: The method of any of clauses 24-27, further comprising determining, by a communication unit of the optimizer system, routing of input data received from a second UE device involved in the XR session and intermediate results to the UE device.

Clause 29: The method of clause 28, wherein determining the routing comprises determining one or more access networks and a core network through which the input data and the intermediate results are to be routed.

Clause 30: The method of any of clauses 28 and 29, further comprising: receiving first network measurements for connections between the UE device and the at least one server device; and receiving second network measurements for connections between the UE device and the second, different server device; wherein determining the first subset of the first set of XR media data rendering tasks comprises determining the first subset of the first set of XR media data rendering tasks according to the first network measurements, and wherein determining the second subset of the first set of XR media data rendering tasks comprises determining the second subset of the first set of XR media data rendering tasks according to the second network measurements.

Clause 31: The method of clause 30, wherein receiving the first network measurements comprises initiating, by the optimizer system, the first network measurements; and wherein receiving the second network measurements comprises initiating, by the optimizer system, the second network measurements.

Clause 32: The method of any of clauses 30 and 31, wherein receiving the first network measurements comprises initiating, by the optimizer system, reporting of the first network measurements; and wherein receiving the second network measurements comprises initiating, by the optimizer system, reporting of the second network measurements.

Clause 33: An optimizer system for processing extended reality (XR) media data, the optimizer system comprising: a memory configured to store optimization configuration data; and a processing system comprising one or more processors implemented in circuitry, the processing system being configured to: determine, according to the optimization configuration data, a first set of XR media data rendering tasks of an XR session to be performed by at least one server device and a second set of XR media data rendering tasks of the XR session to be performed by a user equipment (UE) device; send a first set of instructions to the at least one server device representative of the first set of XR media data rendering tasks to cause the at least one server device to perform the first set of XR media data rendering tasks of the XR session; and send a second set of instructions to the UE device representative of the second set of XR media data rendering tasks to cause the UE device to perform the second set of XR media data rendering tasks.

Clause 34: The optimizer system of clause 33, wherein to determine the first set of XR media data rendering tasks, the processing system is configured to: determine a first subset of the first set of XR media data rendering tasks to be performed by the at least one server device; and determine a second subset of the first set of XR media data rendering tasks to be performed by a second, different server device.

Clause 35: The optimizer system of clause 34, wherein the processing system includes a split compute unit implemented in circuitry and configured to determine the first subset and the second subset.

Clause 36: The optimizer system of any of clauses 34 and 35, wherein the processing system is further configured to receive compute capabilities of the at least one server device and the second, different server device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 37: The optimizer system of any of clauses 33-36, wherein the processing system comprises a communication unit implemented in circuitry and configured to determine routing of input data received from a second UE device involved in the XR session and intermediate results through one or more access networks and a core network to the UE device.

Clause 38: The optimizer system of clause 37, wherein the communication unit is further configured to: receive first network measurements for connections between the UE device and the at least one server device; and receive second network measurements for connections between the UE device and the second, different server device; wherein the communication unit is configured to determine the first subset of the first set of XR media data rendering tasks according to the first network measurements, and wherein the communication unit is configured to determine the second subset of the first set of XR media data rendering tasks according to the second network measurements.

Clause 39: The optimizer system of clause 38, wherein the communication unit is configured to initiate the first network measurements; and wherein the communication unit is configured to initiate the second network measurements.

Clause 40: The optimizer system of any of clauses 38 and 39, wherein the communication unit is configured to initiate reporting of the first network measurements to initiate reporting of the second network measurements.

Clause 41: A method of processing extended reality (XR) media data, the method comprising: receiving, by a network rendering device configured to partially render XR media data and from an optimizer system, a set of instructions representative of a first set of XR media data rendering tasks to be performed on XR media data of an XR session, wherein a user equipment (UE) device participates in the XR session; receiving, by the network rendering device, the XR media data of the XR session; performing, by the network rendering device, the first set of XR media data rendering tasks on the XR media data to form partially rendered XR media data; and sending, by the network rendering device, the partially rendered XR media data to the UE device.

Clause 42: The method of clause 41, further comprising sending, to the optimizer system, compute capabilities of the network rendering device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 43: The method of any of clauses 41 and 42, further comprising sending network measurements for connections between the UE device and the network rendering device to the optimizer system.

Clause 44: A network rendering device for partially rendering extended reality (XR) media data, the network rendering device comprising: a memory configured to store XR media data; and a processing system comprising one or more processors implemented in circuitry, the processing system being configured to: receive, from an optimizer system, a set of instructions representative of a first set of XR media data rendering tasks to be performed on XR media data of an XR session, wherein a user equipment (UE) device participates in the XR session; receive the XR media data of the XR session; perform the first set of XR media data rendering tasks on the XR media data to form partially rendered XR media data; and send the partially rendered XR media data to the UE device.

Clause 45: The network rendering device of clause 44, wherein the processing system is further configured to send, to the optimizer system, compute capabilities of the network rendering device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

Clause 46: The network rendering device of any of clauses 44 and 45, wherein the processing system is further configured to send network measurements for connections between the UE device and the network rendering device to the optimizer system.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing extended reality (XR) media data, the method comprising:
determining, by an optimizer system, a first set of XR media data rendering tasks of an XR session to be performed by at least one server device and a second set of XR media data rendering tasks of the XR session to be performed by a first user equipment (UE) device;
sending, by the optimizer system, a first set of instructions to the at least one server device representative of the first set of XR media data rendering tasks to cause the at least one server device to perform the first set of XR media data rendering tasks of the XR session;
sending, by the optimizer system, a second set of instructions to the first UE device representative of the second set of XR media data rendering tasks to cause the first UE device to perform the second set of XR media data rendering tasks; and
determining, by a communication unit of the optimizer system, routing of input data received from a second UE device involved in the XR session and intermediate results to the first UE device.

2. The method of claim 1, wherein determining the first set of XR media data rendering tasks comprises:
determining a first subset of the first set of XR media data rendering tasks to be performed by the at least one server device; and
determining a second subset of the first set of XR media data rendering tasks to be performed by a second, different server device.

3. The method of claim 2, wherein determining the first subset and the second subset comprises determining the first subset and the second subset by a split compute unit of the optimizer system.

4. The method of claim 2, further comprising receiving, by the optimizer system, compute capabilities of the at least one server device and the second, different server device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

5. The method of claim 2, wherein determining the routing comprises determining one or more access networks and a core network through which the input data and the intermediate results are to be routed.

6. The method of claim 2, further comprising:
receiving first network measurements for connections between the first UE device and the at least one server device; and
receiving second network measurements for connections between the first UE device and the second, different server device;
wherein determining the first subset of the first set of XR media data rendering tasks comprises determining the first subset of the first set of XR media data rendering tasks according to the first network measurements, and
wherein determining the second subset of the first set of XR media data rendering tasks comprises determining the second subset of the first set of XR media data rendering tasks according to the second network measurements.

7. The method of claim 6, further comprising:
initiating, by the optimizer system, the first network measurements; and
initiating, by the optimizer system, the second network measurements.

8. The method of claim 6, further comprising:
initiating, by the optimizer system, reporting of the first network measurements; and
initiating, by the optimizer system, reporting of the second network measurements.

9. The method of claim 1, further comprising receiving a request for split rendering for the XR session from the first UE device, the request including one or more of session information for the XR session, media capability and compute capability for the first UE device, an application for the XR session, XR content of the XR session, a task or subtasks associated with the XR session, a desired split point, a required delay or throughput for the XR session, a quality of service (QOS) or quality of experience (QoE) requirement, a location of the first UE device, or access networks accessible by the first UE device.

10. An optimizer system for processing extended reality (XR) media data, the optimizer system comprising:
a memory configured to store optimization configuration data; and
a processing system comprising one or more processors implemented in circuitry, the processing system being configured to:
determine, according to the optimization configuration data, a first set of XR media data rendering tasks of an XR session to be performed by at least one server device and a second set of XR media data rendering tasks of the XR session to be performed by a first user equipment (UE) device;
send a first set of instructions to the at least one server device representative of the first set of XR media data rendering tasks to cause the at least one server device to perform the first set of XR media data rendering tasks of the XR session; and
send a second set of instructions to the first UE device representative of the second set of XR media data rendering tasks to cause the first UE device to perform the second set of XR media data rendering tasks,
the processing system further comprising a communication unit implemented in circuitry and configured to determine routing of input data received from a second UE device involved in the XR session and intermediate results through one or more access networks and a core network to the first UE device.

11. The optimizer system of claim 10, wherein to determine the first set of XR media data rendering tasks, the processing system is configured to:
determine a first subset of the first set of XR media data rendering tasks to be performed by the at least one server device; and
determine a second subset of the first set of XR media data rendering tasks to be performed by a second, different server device.

12. The optimizer system of claim 11, wherein the processing system includes a split compute unit implemented in circuitry and configured to determine the first subset and the second subset.

13. The optimizer system of claim 11, wherein the processing system is further configured to receive compute capabilities of the at least one server device and the second, different server device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

14. The optimizer system of claim 11, wherein the communication unit is further configured to:
receive first network measurements for connections between the first UE device and the at least one server device; and
receive second network measurements for connections between the first UE device and the second, different server device;
wherein the communication unit is configured to determine the first subset of the first set of XR media data rendering tasks according to the first network measurements, and
wherein the communication unit is configured to determine the second subset of the first set of XR media data rendering tasks according to the second network measurements.

15. The optimizer system of claim 14,
wherein the communication unit is configured to initiate the first network measurements; and
wherein the communication unit is configured to initiate the second network measurements.

16. The optimizer system of claim 14, wherein the communication unit is configured to initiate reporting of the first network measurements to initiate reporting of the second network measurements.

17. A method of processing extended reality (XR) media data, the method comprising:
receiving, by a network rendering device configured to partially render XR media data and from an optimizer system, a set of instructions representative of a first set of XR media data rendering tasks to be performed on XR media data of an XR session, wherein a user equipment (UE) device participates in the XR session;
receiving, by the network rendering device, the XR media data of the XR session;
performing, by the network rendering device, the first set of XR media data rendering tasks on the XR media data to form partially rendered XR media data; and
sending, by the network rendering device, the partially rendered XR media data to the UE device.

18. The method of claim 17, further comprising sending, to the optimizer system, compute capabilities of the network rendering device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

19. The method of claim 17, further comprising sending network measurements for connections between the UE device and the network rendering device to the optimizer system.

20. A network rendering device for partially rendering extended reality (XR) media data, the network rendering device comprising:
a memory configured to store XR media data; and
a processing system comprising one or more processors implemented in circuitry, the processing system being configured to:
receive, from an optimizer system, a set of instructions representative of a first set of XR media data rendering tasks to be performed on XR media data of an XR session, wherein a user equipment (UE) device participates in the XR session;
receive the XR media data of the XR session;
perform the first set of XR media data rendering tasks on the XR media data to form partially rendered XR media data; and
send the partially rendered XR media data to the UE device.

21. The network rendering device of claim 20, wherein the processing system is further configured to send, to the optimizer system, compute capabilities of the network rendering device, the compute capabilities including one or more of: available hardware including a central processing unit (CPU), a graphics processing unit (GPU), a network processing unit (NPU), or available random access memory (RAM); available software including one or more video encoder/decoders (CODECs) or neural network modules; compute pricing; energy consumption; battery status; or heat conditions.

22. The network rendering device of claim 20, wherein the processing system is further configured to send network measurements for connections between the UE device and the network rendering device to the optimizer system.
